(19) United States
(12) Patent Application Publication
(10) Pub. No.: US 2026/0031721 A1
(43) Pub. Date: Jan. 29, 2026

(54) POWER CONVERTER WITH STABILITY CONTROL

(71) Applicant: Texas Instruments Incorporated, Dallas, TX (US)

(72) Inventors: Weiyu Tai, HUAIAN CITY (CN); Guangzhi Cui, Shanghai (CN); Sheng-Yang Yu, Frisco, TX (US)

(21) Appl. No.: 18/780,481

(22) Filed: Jul. 23, 2024

(51) Int. Cl. H02M 3/00; H02M 1/00; H02M 7/527

(52) U.S. Cl. CPC H02M 3/015; H02M 1/0043; H02M 1/0064; H02M 7/527

(57) ABSTRACT

In described examples, a resonant converter includes a primary side, a secondary side, and a controller. The primary side includes a primary full bridge coupled to a primary winding. The primary full bridge includes first and second high-side primary switches and first and second low-side primary switches. The secondary side includes a secondary full bridge coupled to a secondary winding. The secondary full bridge includes two high-side secondary switches and two low-side secondary switches. The controller operates the resonant converter in a phase shift mode with an overlapping phase and a non-overlapping phase. In the overlapping phase the first high-side primary switch and the first low-side primary switch are closed. In the non-overlapping phase either the first high-side primary switch or the first low-side primary switch is closed and the other is open. The controller closes either the two high-side or the two low-side secondary switches during the non-overlapping phase.

### TECHNICAL FIELD

This application relates generally to an electronic system and method, and, in particular embodiments, to a resonant power converter.

### BACKGROUND

Power converters are used in a variety of applications, such as industrial and automotive applications, to convert power from a first voltage regime to a second voltage regime. In some examples, power converters regulate to a designed gain in response to a sensed, controlled voltage or in response to a sensed, controlled current. Examples of power converters include inductor-inductor-capacitor (LLC) converters and capacitor-inductor-inductor-inductor-capacitor (CLLLC) converters.

### SUMMARY

In described examples, a resonant converter includes a primary side, a secondary side, and a controller. The primary side includes a primary full bridge coupled to a primary winding. The primary full bridge includes first and second high-side primary switches and first and second low-side primary switches. The secondary side includes a secondary full bridge coupled to a secondary winding. The secondary full bridge includes two high-side secondary switches and two low-side secondary switches. The controller operates the resonant converter in a phase shift mode with an overlapping phase and a non-overlapping phase. In the overlapping phase the first high-side primary switch and the first low-side primary switch are closed. In the non-overlapping phase either the first high-side primary switch or the first low-side primary switch is closed and the other is open. The controller closes either the two high-side or the two low-side secondary switches during the non-overlapping phase.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a functional block diagram of an example power management system that includes a bi-directional isolated direct current to direct current (DC/DC) power converter, according to an embodiment of this disclosure;

FIG. 2 is a functional block and circuit diagram of an example power converter system that includes a CLLLC converter, according to an embodiment of this disclosure;

FIG. 3 is a graph of example gain versus frequency, for various Q factors, of the power converter system of FIG. 2, without parasitic capacitances, according to an embodiment of this disclosure;

FIG. 3B is a graph of example gain versus frequency, for various Q factors, of the power converter system of FIG. 2, with parasitic capacitances, according to an embodiment of this disclosure;

FIG. 4A is a first example phase shift angle control scheme for the CLLLC converter of FIG. 2;

FIG. 4B is a second example phase shift angle control scheme for the CLLLC converter of FIG. 2;

FIG. 5 is a third example phase shift angle control scheme for the CLLLC converter of FIG. 2, according to an embodiment of this disclosure;

FIG. 6A is an example phase shift control scheme that is a first alternative to the phase shift control scheme of FIG. 5 for the CLLLC converter of FIG. 2, according to an embodiment of this disclosure;

FIG. 6B is an example timing diagram phase shift control scheme that is a second alternative to the phase shift control scheme of FIG. 5 for the CLLLC converter of FIG. 2, according to an embodiment of this disclosure;

FIG. 7 is an example graph of gain versus phase shift angle for the CLLLC converter of FIG. 2 using the control scheme of FIG. 5, according to an embodiment of this disclosure;

FIG. 8A is a flow diagram of an example process for control of the power converter system of FIG. 2, according to an embodiment of this disclosure; and

FIG. 8B is a flow diagram of an example process for control of the power converter system of FIG. 2 in phase shift mode, according to an embodiment of this disclosure.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The description below illustrates the various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Examples described below include improved power converter applications, which include charging and discharging batteries in energy storage systems (ESS), power conversion systems (PCS), programmable power supplies (PPS), and uninterruptible power supplies (UPS). In some examples, under light load, frequency modulation control for a switched resonant power converter can reach a maximum modulation frequency corresponding to a minimum gain reachable using frequency modulation. In such examples, a phase shift mode can be used to further reduce gain. However, under certain conditions, parasitic capacitances of secondary side switches can participate in the resonance, introducing nonlinearity into gain control. Turning on both high-side or both low-side secondary side switches prior to an energy transfer phase of the switched resonant power converter can help reduce or prevent such nonlinearities.

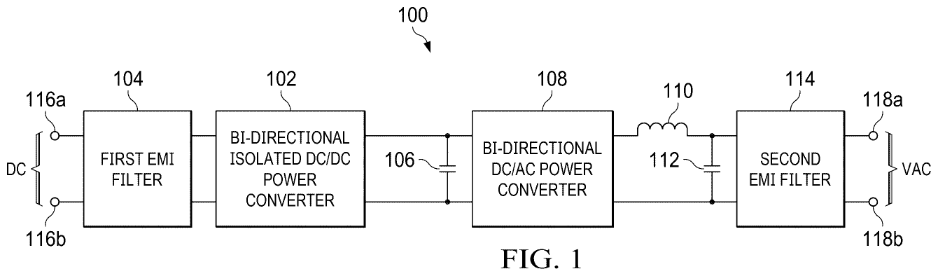

FIG. 1 is a functional block diagram of an example power management system 100 that includes a bi-directional isolated direct current to direct current power converter 102, according to an embodiment of this disclosure. In some examples, the power management system 100 is a charger for a battery, such as a DC 48 volt (V) car battery. The power management system 100 includes a first electromagnetic interference (EMI) filter 104, a first capacitor 106, a bi-directional direct current to alternating current (DC/AC) power converter 108, an inductor 110, a second capacitor 112, and a second EMI filter 114.

The power management system 100 is bi-directional, enabling a battery (a DC power source) connected to first and second input/output (I/O) terminals 116a and 116b to charge and discharge responsive to an alternating current (AC) source or an AC load connected to third and fourth I/O terminals 118a and 118b. The AC source, such as a charging station, and AC load, such as an electric car motor and power system, are selectably connected to the third and fourth terminals 118a and 118b. In some examples, the AC source and AC load provide or use 220 VAC power.

Connections of the power management system 100 are described with respect to directions as they visually appear in FIG. 1, accordingly, left and right. Because the power management system 100 is bi-directional, power flow may be to the left or to the right depending on whether the DC power source connected to the first and second I/O terminals 116 is charging or discharging, respectively. Similarly, power flow may be to the left or to the right depending on whether the AC source or load connected to the third and fourth I/O terminals is providing power to charge the DC power source, or receiving power discharged by the DC power source, respectively.

The first and second I/O terminals 116a and 116b are connected to the left side of the first EMI filter 104. The right side of the first EMI filter 104 is bi-directionally connected (both directions) by a first conductor pair to the bi-directional isolated DC/DC converter 102. The right side of the bi-directional isolated DC/DC converter 102 is bi-directionally connected by a second conductor pair to the bi-directional DC/AC power converter 108. The first capacitor 106 is connected between the second conductor pair.

The right side of the bi-directional DC/AC power converter 108 is bi-directionally connected, through a third conductor pair and an inductive/capacitive circuit, to the second EMI filter 114. Particularly, a first right side terminal of the bi-directional DC/AC power converter 108 is connected to a first terminal of the inductor 110, and a second terminal of the inductor 110 is connected to a first terminal of the second capacitor 112 and a first left side terminal of the second EMI filter 114. A second right side terminal of the bi-directional DC/AC power converter 108 is connected to a second terminal of the second capacitor 112 and a second left side terminal of the second EMI filter 114.

The second EMI filter 114 is connected on its right side to the third and fourth I/O terminals 118a and 118b. Depending on a direction of power flow (in the rightward direction or leftward direction), connections of components of the power management system 100 in the rightward direction or the leftward direction correspond to input, and connections in the other direction (the leftward or rightward direction, respectively) correspond to output.

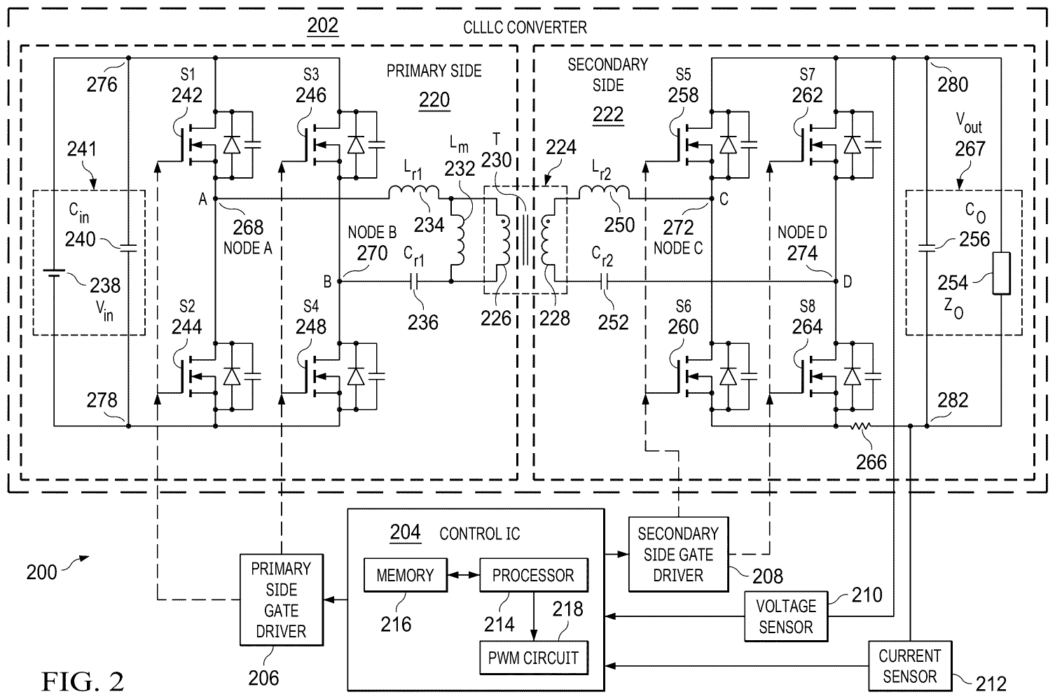

FIG. 2 is a functional block and circuit diagram of an example power converter system 200 that includes a CLLLC converter 202, according to an embodiment of this disclosure. In some examples, the CLLLC converter 202 is a bi-directional isolated DC/DC power converter, such as the bi-directional isolated DC/DC power converter 102 of FIG. 1.

The power converter system 200 includes a controller 204 (e.g., as an integrated circuit), a primary side gate driver 206, a secondary side gate driver 208, a voltage sensor 210, and a current sensor 212. The control integrated circuit (IC) 204 includes a processor 214 (or other control circuit), a memory 216 storing instructions for execution by the processor 214, and a pulse width modulation (PWM) circuit 218.

The CLLLC converter 202 includes a primary side 220 and a secondary side 222. Transformer 224 enables energy transfer from the primary side 220 to the secondary side 222. In some examples, the transformer 224 also enables energy transfer from the secondary side 222 to the primary side 220. The transformer 224 includes a primary winding 226 on the primary side 220, a secondary winding 228 on the secondary side 222, and an isolation 230 between the primary winding 226 and the secondary winding 228. The primary winding 226 and the secondary winding 228 are magnetically coupled to each other. In some examples, the transformer 224 includes a ferromagnetic core, such as an iron core. In some examples, the isolation 230 includes an air gap.

A transformer, such as the transformer 224, can be modeled as having a magnetizing inductance (Lₘ) 232 and a leakage inductance (not shown). The magnetizing inductance Lₘ 232 represents the inductance that magnetically couples between the primary and secondary windings 226 and 228, and leakage inductance represents the inductance that does not so couple. The magnetizing inductance Lₘ 232 can be modeled as being connected in parallel with any of the transformer's coils because the impedances across each of the coils is reflected across each of the other coils.

The primary side 220 includes the magnetizing inductance Lₘ 232, a first resonant inductor (Lᵣ₁) 234, a first resonant capacitor (Cᵣ₁) 236, a voltage source (Vᵢₙ) 238, an input capacitor (Cᵢₙ) 240, a first high-side primary switch (S1) 242, a first low-side primary switch (S2) 244, a second high-side primary switch (S3) 246, and a second low-side primary switch (S4) 248. The voltage source 238 and the input capacitor 240 together form a power source 241.

The secondary side 222 includes a second resonant inductor (Lᵣ₂) 250, a second resonant capacitor (Cᵣ₂) 252, an output impedance (Z_{O}) 254, an output capacitance (C_{O}) 256, a first high-side secondary switch (S5) 258, a first low-side secondary switch (S6) 260, a second high-side secondary switch (S7) 262, a second low-side secondary switch (S8) 264, and a sense resistor 266. Together, Lᵣ₁ 234, Lₘ 232, Cᵣ₁ 236, Lᵣ₂ 250, and Cᵣ₂ 252 form a resonant network. Accordingly, the CLLLC converter 202 is referred to as a resonant power converter. Z_{O} 254 and C_{O} 256, connected in parallel, together form a load 267 driven by the CLLLC converter 202.

S1 242, S2 244, S3 246, and S4 248 may be referred to as the primary side switches 242, 244, 246, and 248, respectively. S5 258, S6 260, S7 262, and S8 264 may be referred to as the secondary side switches 258, 260, 262, and 264, respectively.

In some examples, each of the switches 242, 244, 246, 248, 258, 260, 262, and 264 is a silicon carbide metal-oxide-semiconductor field-effect transistor (MOSFET), and the respective control terminal is a gate. In some examples, each of the switches 242, 244, 246, 248, 258, 260, 262, and 264 is an n-channel silicon carbide MOSFET, respective high-side terminals are drains, and respective low-side terminals are sources. In some examples, another type of MOSFET or other transistors or equivalent device is used.

Each of the switches 242, 244, 246, 248, 258, 260, 262, and 264 includes a body diode and a parasitic capacitance. An anode of each body diode is coupled to a low-side terminal of its respective switch 242, 244, 246, 248, 258, 260, 262, or 264. A cathode of each body diode is coupled to a high-side terminal of its respective switch 242, 244, 246, 248, 258, 260, 262, or 264. Each parasitic capacitance has a first terminal coupled to the high-side terminal of its respective switch 242, 244, 246, 248, 258, 260, 262, or 264 and a second terminal coupled to the low-side terminal of its respective switch 242, 244, 246, 248, 258, 260, 262, or 264.

A positive terminal of Vᵢₙ 238 is connected to a first terminal of Cᵢₙ 240, a high-side terminal of S1 242, and a high-side terminal of S3 246. A negative terminal of Vᵢₙ 238 is connected to a second terminal of Cᵢₙ 240, a low-side terminal of S2 244, and a low-side terminal of S4 248. A node A 268 is connected to a low-side terminal of S1 242, a high-side terminal of S2 244, and a first terminal of Lᵣ₁ 234. A node B 270 is connected to a low-side terminal of S3 246, a high-side terminal of S4 248, and a first terminal of Cᵣ₁ 236. A second terminal of Lᵣ₁ 234 is connected to a first terminal of Lₘ 232 and a first terminal of the primary winding 226. A second terminal of Cᵣ₁ 236 is connected to a second terminal of Ln 232 and a second terminal of the primary winding 226.

A first (high-side) terminal of Z_{O} 254 is connected to a first terminal of C_{O} 256, a high-side terminal of S5 258, a high-side terminal of S7 262, and an input terminal of the voltage sensor 210. A second (low-side) terminal of Z_{O} 254 is connected to a second terminal of C_{O} 256, a first terminal of the sense resistor 266, and an input terminal of the current sensor 212. A second terminal of the sense resistor 266 is connected to a low-side terminal of S6 260 and a low-side terminal of S8 264. A node C 272 is connected to a low-side terminal of S5 258, a high-side terminal of S6 260, and a first terminal of Lᵣ₂ 250. A node D 274 is connected to a low-side terminal of S7 262, a high-side terminal of S8 264, and a first terminal of Cᵣ₂ 252. A second terminal of Lᵣ₂ 250 is connected to a first terminal of the secondary winding 228. A second terminal of Cᵣ₂ 252 is connected to a second terminal of the secondary winding 228. Accordingly, the primary side 220 includes a first full bridge circuit and the secondary side 222 includes a second full bridge circuit.

Each of the switches 242, 244, 246, 248, 258, 260, 262, and 264 has a control terminal. The control terminal of each of the primary side switches 242, 244, 246, and 248 is connected to a respective output of the primary side gate driver 206. The control terminal of each of the secondary side switches 258, 260, 262, and 264 is connected to a respective output of the secondary side gate driver 208.

The primary side switches 242, 244, 246, and 248 control current flow through the primary winding 226 and, accordingly, transfer of energy from the primary winding 226 to the secondary winding 228. The secondary side switches 258, 260, 262, and 264 form a rectifier to rectify current on the secondary side 222. Accordingly, the switches 242, 244, 246, 248, 258, 260, 262, and 264 together control energy transfer from the voltage source 238, across the transformer 224, to the load 267.

The voltage sensor 210 and the current sensor 212 provide their respective outputs to the processor 214. Accordingly, an output of the voltage sensor 210 is connected to a first input of the control IC 204, such as via a first optocoupler. An output of the current sensor 212 is connected to a second input of the control IC 204, such as via a second optocoupler. The processor 214 controls the PWM circuit 218 in response to executing instructions stored by the memory 216 and in response to signals received from the voltage sensor 210 and the current sensor 212. In response to control signals received from the processor 214, the PWM circuit 218 controls the primary side gate driver 206 to open and close the primary side switches 242, 244, 246, and 248, and controls the secondary side gate driver 208 to open and close the secondary side switches 258, 260, 262, and 264.

When S1 242 and S4 248 are on and S2 244 and S3 246 are off, current flowing from the positive terminal of the voltage source 238, through Lᵣ₁ 234, and through the primary winding 226 increases. This increase in current flow on the primary side 220 is in a direction from node A 268 to node B 270 (an “AB” direction). While current flows through the primary winding 226 towards Cᵣ₁ 236 (in the AB direction), Cᵣ₁ 236 charges and the primary winding 226 generates a magnetic flux that causes a magnetic core (not shown) to store magnetic energy with a first polarity. A duration (a half-period) from when a first one of S1 242 or S4 S48 turns on to when a first one of S2 244 or S3 246 turns on is referred to herein as a first phase of the CLLLC converter 202.

When S2 244 and S3 246 are on and S1 242 and S4 248 are off, current flowing from Cᵣ₁ 236, through the primary winding 226, and through Lᵣ₁ 234, towards the negative terminal of the voltage source 118 increases. This increase in current flow on the primary side 220 is in in a direction from node B 270 to node A 268 (a “BA” direction). While current flows through the primary winding 226 towards the negative terminal of the voltage source 238 (in the BA direction), Cᵣ₁ 236 discharges and the primary winding 226 generates a magnetic flux that causes the magnetic core to store magnetic energy with a second polarity. A duration from when a first one of S2 244 or S3 246 turns on to when a first one of S1 242 or S4 S48 turns on is referred to herein as a second phase of the CLLLC converter 202.

Magnetic flux generated by the primary winding 226 induces current in the secondary winding 228 that is rectified by the secondary switches 258, 260, 262, and 264 to provide direct current (DC) power to the load 267. In a first example implementation, pairs of the secondary switches 258, 260, 262, and 264 are closed to provide relatively low impedance current paths for current induced in the secondary side 222 by the magnetic flux applied on the ferromagnetic core by current through the primary side 220. In a second example implementation, the secondary switches 258, 260, 262, and 264 are kept open so that the body diodes of the secondary switches 258, 260, 262, and 264 passively rectify current induced in the secondary side 222. The first implementation or the second implementation may be used responsive to, for example, available control resources, a designed efficiency of the CLLLC converter 202, or a load condition of the power converter system 200.

In the first example implementation, while S1 242 and S4 248 are closed and S2 244 and S3 246 are open, S5 258 and S8 264 close and S6 260 and S7 262 open. Current flow through the primary side 220 in the AB direction increases, so that current flowing from a high-side terminal of the load 254, through Lᵣ₂ 250, and through the secondary winding 228 increases. This increase in current flow on the secondary side 228 is in a direction from node C 272 to node D 274 (a “CD” direction). While current flows through the secondary winding 228 towards Cᵣ₂ 252 (in the CD direction), Cᵣ₂ 252 charges.

While S1 242 and S4 248 are open and S2 244 and S3 246 are closed, S5 258 and S8 264 open and S6 260 and S7 262 close. Current flow through the primary side 220 in the BA direction increases, so that current flowing from Cᵣ₂ 252, through the secondary winding 228, through Lᵣ₂ 250, to the high-side terminal of the load 254 increases. This increase in current flow on the secondary side 228 is in a direction from node D 274 to node C 272 (a “DC” direction). While current flows from Cᵣ₂ 252 through the secondary winding 228 (in the DC direction), Cᵣ₂ 252 discharges.

In the second implementation, the secondary switches 258, 260, 262, and 264 remain off throughout a converter control period (one switching cycle). Herein, this is referred to as operation in diode mode, because rectification is performed using the body diodes of the 258, 260, 262, and 264. In some examples, diode mode can be performed with design-compliant efficiency when there is a light load condition so that current through the secondary winding 228 is relatively low.

In a first phase, current flow through the primary side 220 in the AB direction increases so that current flow through the secondary side 222 in the CD direction increases. In the first phase, a current path on the secondary side 222 is provided by the body diodes of S5 258 and S8 264. In a second phase, current flow through the primary side 220 in the BA direction increases so that current flow through the secondary side 222 in the DC direction increases. In the second phase, a current path on the secondary side 222 is provided by the body diodes of S6 260 and S7 262.

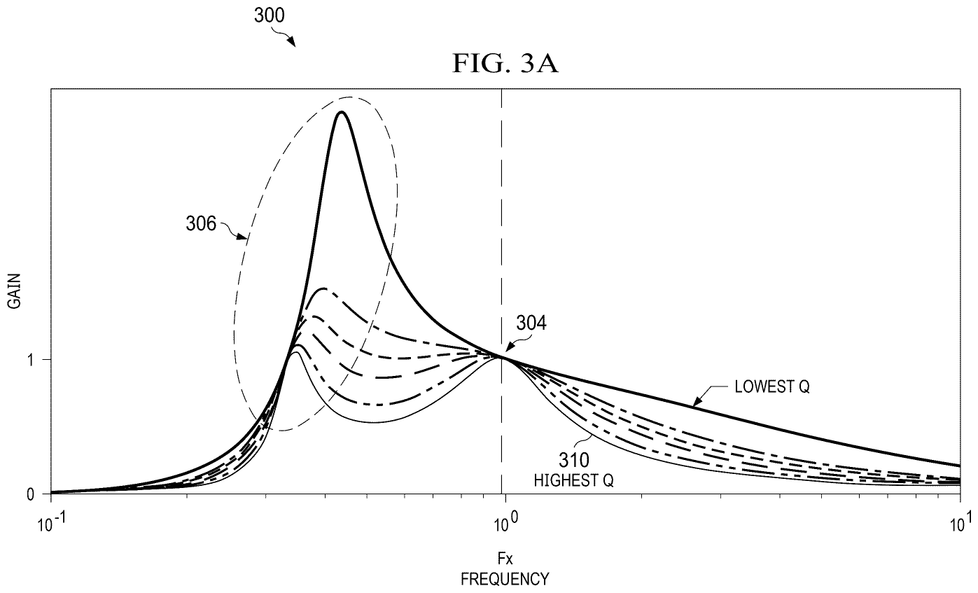

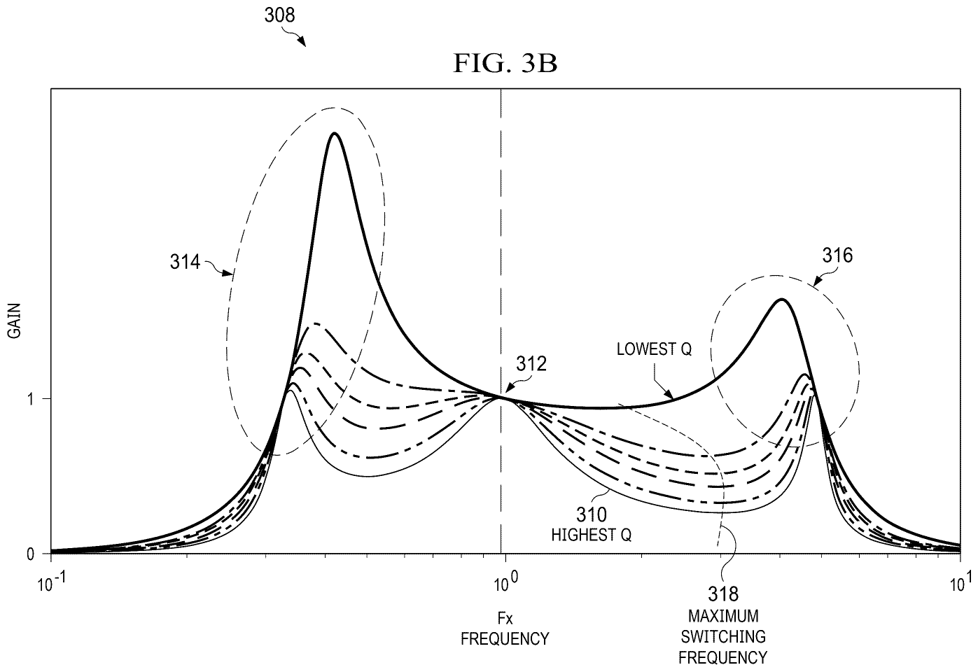

Control of the CLLLC converter 202 using the switches 242, 244, 246, 248, 258, 260, 262, and 264 is further described with respect to FIGS. 3 through 8B.

In the power converter system 200 illustrated in FIG. 2, power is transferred from the left hand side (the primary side 220) to the right hand side (the secondary side 222). In some examples, a power converter system 200 includes a voltage sensor such as the voltage sensor 210 and/or includes a current sensor such as the current sensor 212 on the primary side 220 to enable the secondary side 222 to function as the primary side 220, and the primary side 220 to function as the secondary side.

Accordingly, in some examples, this enables the CLLLC converter 202 to be controlled to transfer energy from the right hand side (the secondary side 222, acting as a primary side) to the left hand side (the primary side 220, acting as a secondary side). In such examples, the power converter system 200 is configured to perform the functions of the bi-directional isolated DC/DC power converter 102 of FIG. 1.

A first terminal 276 is connected to the positive terminal of Vᵢₙ 238 and the first terminal of Cᵢₙ 240. A second terminal 278 is connected to the negative terminal of the voltage source 238 and the second terminal of the input capacitor 240. A third terminal 280 is connected to the first terminal of Z_{O} 254 and the first terminal of C_{O} 256. A fourth terminal 282 is connected to the second terminal of Z_{O} 254 and the second terminal of C_{O} 256. The first terminal 276 is connected to the third I/O terminal 118a and the second terminal 278 is connected to the fourth I/O terminal 118b. The third terminal 280 is connected to the first I/O terminal 116a and the second terminal 282 is connected to the second I/O terminal 116b. In examples in which the power converter system 200 is configured to perform the functions of the bi-directional isolated DC/DC power converter 102, the switches 242, 244, 246, 248, 258, 260, 262, and 264 can be controlled to direct power from the first and second I/O terminals 116 to the third and fourth I/O terminals 118, or from the third and fourth I/O terminals 118 to the first and second I/O terminals 116.

In some embodiments, control IC 204 may include primary side gate driver 206, and secondary side gate driver 208. In some embodiments, control IC 204 may include voltage sensor 210 and/or current sensor 212.

In some embodiments, controller 204 may be implemented with a processor (e.g., 214), e.g., capable of executing instructions stored in a memory (e.g., 216), such as shown in FIG. 2. In some embodiment, controller 204 may be implemented as a generic or custom controller or processor, or as a field programmable gate array (FPGA). In some embodiments, controller 204 may include a state machine. In some embodiments, controller 204 may be only partially programmable, or not programmable.

In some embodiments, transistors 242, 244, 246, and 248 may be integrated in an IC.

In some embodiments, transistors 258, 260, 262, and 264 may be integrated in an IC.

In some embodiments, the same IC may include transistors 242, 244, 246, 248, 258, 260, 262, and 264. In some such embodiments, the same IC may also include controller 204, and/or gate drivers 206 and 208.

In some embodiments, pulse-width modulation (PWM) circuit 218 may be used to generate the signals to control transistors 242, 244, 246, 248, 258, 260, 262, and 264.

FIG. 3A is a graph 300 of example gain versus frequency, for various Q factors, of the power converter system 200 of FIG. 2, without parasitic capacitances, according to an embodiment of this disclosure. A vertical axis corresponds to gain, and a horizontal axis corresponds to frequency. The graph includes multiple frequency response lines 302. In some examples, a frequency modulated power converter operates at a fixed duty cycle and adjusts gain by changing a switching frequency of switches controlling power transfer.

Different frequency response lines 302 correspond to different Q factors of the power converter system 200. A unity gain 304 is achieved at a series resonant frequency (Fx). A frequency response line 302 corresponding to a maximum Q factor has a gain peak 306 corresponding to unity gain 306. Frequency response lines 302 corresponding to lower Q factors show higher gain peaks 306 at parallel resonant frequencies, with gain tapering off at frequencies above and below respective gain peaks 306. In some examples, frequency response lines 302 corresponding to a higher Q factor have a narrower or more sharply defined (steeper falloff) gain peak 306.

In some examples, a parallel resonant frequency corresponds to or is designed as a lower limit of a switching frequency of control switches 242, 244, 246, 248, 258, 260, 262, and 264 of a CLLLC power converter 200. This is because the region to the left of the gain peak 306 has a positive slope, which corresponds to the power converter system 200 losing zero voltage switching (ZVS) for the primary switches 242, 244, 246, and 248.

For designed values of Lᵣ₁ 234, Lᵣ₂ 250, Cᵣ₁ 236, and Cᵣ₂ 252, Q factor is responsive to the output load, accordingly, smaller Z_{O} 254 corresponds to higher Q factor. If Q factor is relatively high, gain variation for a unit of frequency modulation will be relatively small and the operating frequency range can be relatively wide. (Meanings of high, small, wide, and similar descriptions are responsive to the specific design considerations and requirements of respective applications.) If Q is relatively low, gain variation for a unit of frequency modulation will be relatively large and the available operating frequency range will be smaller.

In some examples, low Q factor for a normal operating load corresponds to small impedance values of Lᵣ₁ 234, Lᵣ₂ 250, Cᵣ₁ 236, and Cᵣ₂ 252, which can lead to high circulation current and, accordingly, low converter efficiency. In some examples, a designed Q factor for normal operation is responsive to converter efficiency and operating range.

FIG. 3B is a graph 308 of example gain versus frequency, for various Q factors, of the power converter system 200 of FIG. 2, with parasitic capacitances, according to an embodiment of this disclosure. A vertical axis corresponds to gain, and a horizontal axis corresponds to frequency. The graph includes multiple frequency response lines 310.

Unity gain 312 is achieved at the series resonant frequency (Fx). Gain peaks 314 for respective frequency response lines 310 are located at parallel resonant frequencies. Additional local maxima 316 for respective frequency response lines 310 are caused by the presence of the parasitic capacitances of the secondary switches 258, 260, 262, and 264. Responsive to the local maxima 316, there are locations on the frequency response lines 310 between Fx (unity gain 312) and the respective local maxima 316 where the slope of the respective frequency response line 310 is zero (zero gain change in response to change in frequency). In some examples, this zero slope location corresponds to a maximum switching frequency 318 for the power converter system 200 at a corresponding Q factor.

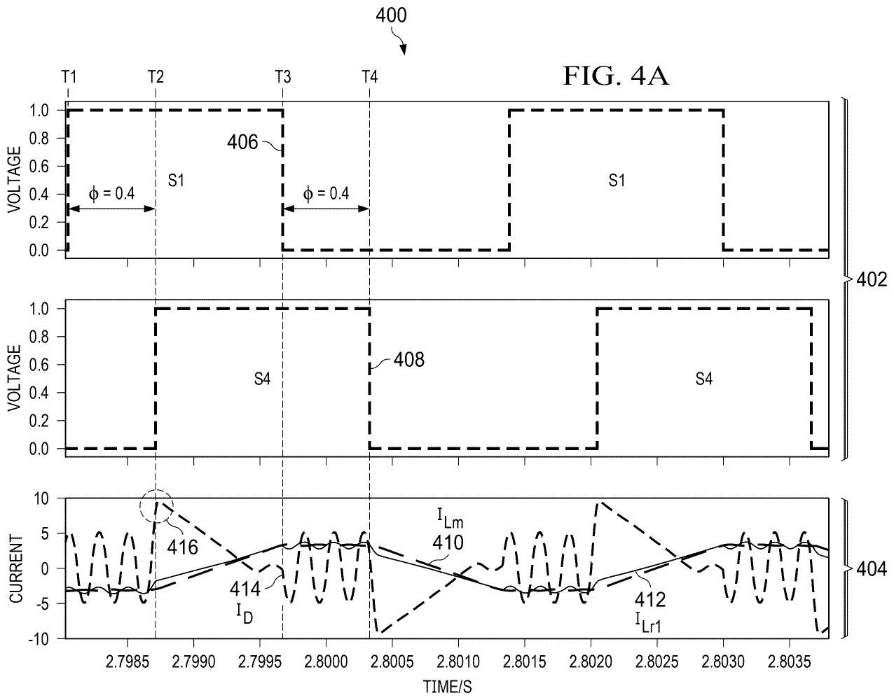

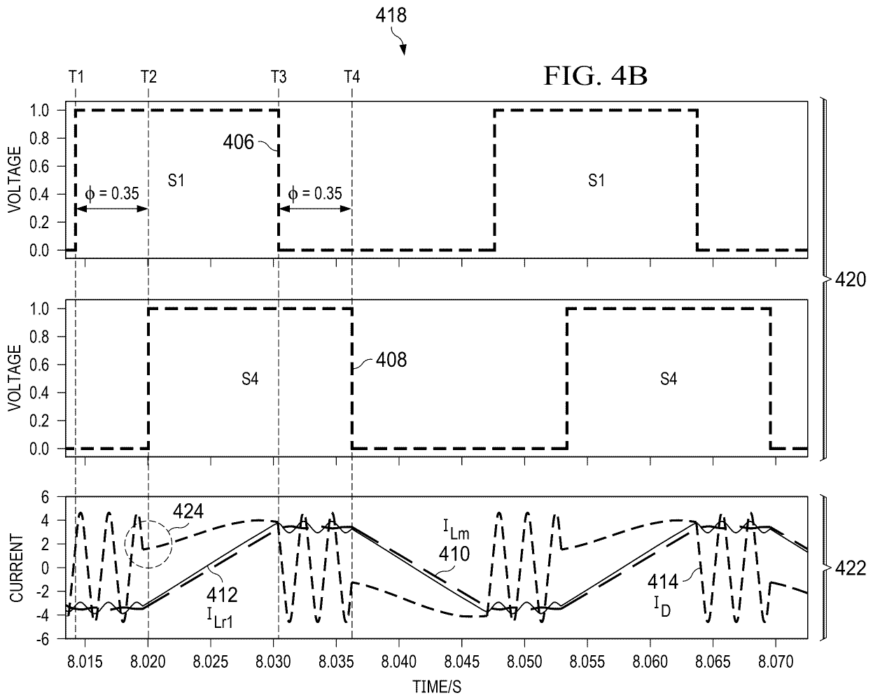

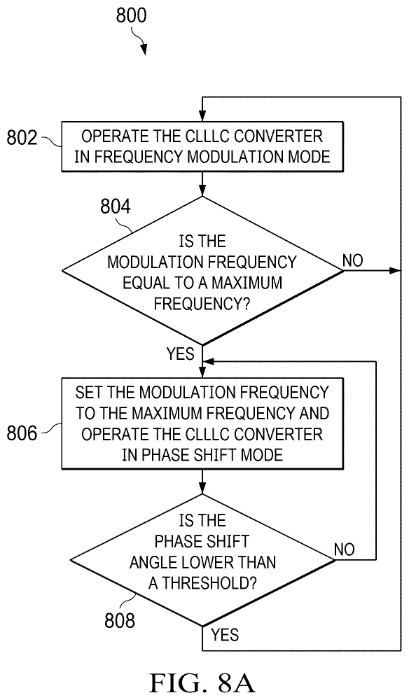

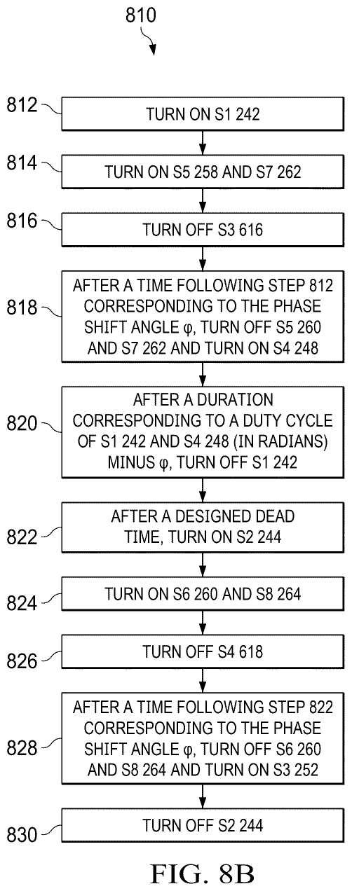

In some examples, the maximum switching frequency 318 corresponds to a light load. Accordingly, at light load, increasing a switching frequency may be insufficient to maintain a designed gain. If the maximum switching frequency 308 is reached but gain needs to be lowered further, the maximum switching frequency 308 is maintained and phase shift angle control (a phase shifting mode) is used to control the primary switches 242, 244, 246, and 248, as further described with respect to FIG. 8A. Phase shift angle control is further described with respect to FIGS. 4A and 4B.

FIG. 4A is a first example phase shift angle control scheme 400 for the CLLLC converter 202 of FIG. 2. The phase shift angle control scheme 400 is illustrated by a timing diagram 402 for the primary switches 242, 244, 246, and 248, with a corresponding graph 404 of current versus time for certain signals of the CLLLC converter 202. A vertical axis of the timing diagram 402 indicates voltage, and a vertical axis of the graph 404 indicates current. A horizontal axis indicates time. The timing diagram 402 shows an S1 control voltage 406 corresponding to activation timing for S1 242, and an S4 control voltage 408 corresponding to activation timing for S4 248. In some examples, the S1 control voltage 406 is a gate-source voltage (Ves) for S1 242, and the S4 control voltage 408 is a Ves for S4 248.

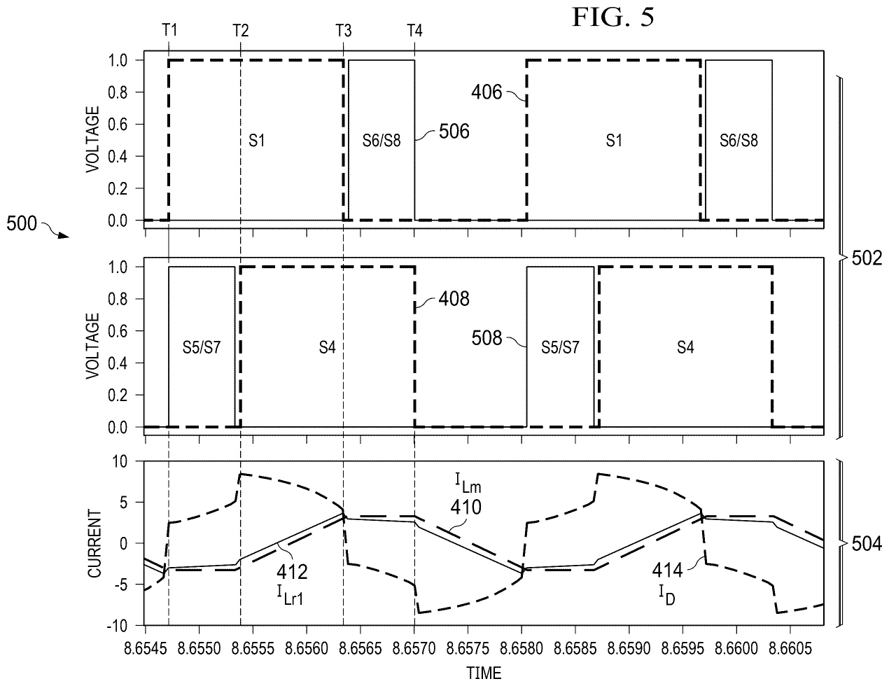

While the S1 control voltage 406 or the S4 control voltage 408 is high (in the illustrated example, one volt), the corresponding switch S1 406 or S4 408 is turned on (closed). While the S1 control voltage 406 or the S4 control voltage 408 is low (in the illustrated example, zero volts), the corresponding switch S1 406 or S4 408 is turned off (opened). Timing for S2 244 and S3 246 (not shown in FIGS. 4A, 4B, and 5) are respectively π radians) (180° out of phase with S1 242 and S4 248.

The graph 404 includes multiple curves indicating current signals in the CLLLC converter 202. On the primary side 220, positive current is in the AB direction. On the secondary side, positive current is in the CD direction. The graph 404 includes a first curve (I_{Lm}) 410 showing current through Lₘ 232, a second curve (I_{Lr1}) 412 showing current through Lᵣ₁ 234, and a third curve (I_{D}) 414 showing current through node D 274.

In the phase shifting mode, on-times and off-times of S1 242 and S4 248 are offset from each other by a phase shift angle φ (phi), which is a portion φ/2π of a switching cycle of the primary side 202. Herein, φ may be measured in radians. Similarly, on-times and off-times of S2 244 and S3 246 are offset from each other by the same phase shift angle φ. In the phase shift control scheme 400, φ=0.4 radians.

In some embodiments, energy is transferred only while both S1 242 and S4 248 are on, or both S2 244 and S3 246 are on. Accordingly, phase shifting mode enables an amount of energy provided by the primary side 220 to and stored in the magnetizing inductance (Lₘ) 232 for transfer to the secondary side 222 to be reduced, thereby reducing gain, without changing a duty cycle or switching frequency of the primary switches 242, 244, 246, and 248. In the illustrated example, an effective duty cycle of the primary side switches 242, 244, 246, and 248, and accordingly a portion of a switching cycle during which energy is transferred, is reduced by φ, accordingly, 0.4 radians.

Primary side 220 switch control during a phase shifted (offset) portion of a control period, when only one of the primary switches 242, 244, 246, or 248 is on, can be described as follows. A first high-side or low-side primary switch 242, 244, 246, or 248 is on, and a second high-side or low-side primary switch 242, 244, 246, or 248 that includes in its current path (a source-drain current path) the primary winding 226 and the first high-side or low-side primary switch 242, 244, 246, or 248 is off. In the illustrated example, from time T1 to time T2, S1 242 is on while S4 244 is off, and from time T3 to time T4, S4 244 is on while S4 244 is off.

In the phase shift control scheme 400, secondary side S5 258 and S8 264 are on while primary side S1 242 and S4 248 are both on, and are off at other times. Similarly, secondary side S6 260 and S7 262 are both on while primary side S2 244 and S3 246 are both on, and are off at other times. This results in the parasitic capacitances of the secondary switches 258, 260, 262, and 264 participating in the resonance during times while the secondary switches 258, 260, 262, and 264 are off. These parasitic capacitances participating in the resonance cause ringing in the current signal I_{D} 414. As further described below and with respect to FIG. 4B, this ringing leads to nonlinearity in gain control of the CLLLC converter 202 using phase shifting.

At time T1, S1 242 turns on and S4 248 remains off. From time T1 to time T2, the primary winding 226 is part of an open circuit (S4 248 is open), so that voltage across the primary winding 226 equals zero and current through I^{Lm} 410 and I_{Lr1} 412 are mostly constant. I_{D} 414 shows ringing responsive to participation of the parasitic capacitances of the secondary switches 258, 260, 262, and 264 in the resonance. In the illustrated example, this ringing corresponds to an oscillation between 5 Amperes and −5 Amperes. There is also ringing in I_{Lr1} 412, at a lesser magnitude than in I_{D} 414, corresponding to reflection from the secondary side 222 (accordingly, from I_{D} 414).

At time T2, S1 242 remains on and S4 248 turns on to enable energy transfer. The delay from S1 242 turning on to S4 248 turning on equals φ, accordingly, 0.4 radians of the switching cycle. At time T2, I_{D} 414 has a first current level 416 responsive to a value of I_{D} 414 prior to S4 248 closing (turning on). The value of I_{D} 414 prior to S4 248 closing is responsive to a nonlinear ringing function while the parasitic capacitances of S5 258 and S8 264 participate in the resonance. When S4 248 turns on, energy begins to transfer from the primary side 220 to the secondary side 222, and a difference between I_{Lm} 410 and I_{Lr1} 412 is reflected across the transformer 224 to the secondary side 222 and is added to I_{D} 414. Accordingly, at time T2, I_{D} 414 jumps from 5 Amperes to nearly 10 Amperes. The amount of energy transferred during the period when S1 242 and S4 248 are on, and accordingly the gain of the CLLLC converter 202 during a corresponding switching half-cycle, is responsive to the level of I_{D} 414 at time T2. In the illustrated example, I_{D} 414 at time T2 is about 10 Amperes.

From time T2 to T3, S1 242 and S4 248 are on and power is transferred from the primary side 220 to the secondary side 222. From T2 to T3, voltage across the primary winding 226 is positive, so that I_{Lm} 410 and I_{Lr1} 412 are increasing. On the secondary side 222, from T2 to T3 I_{D} 414 decreases from 10 Amperes volts to zero Amperes, and then shows a relatively small amount of ringing (in the illustrated example, between less than 1 Ampere and greater than-1 Ampere).

There is no (or reduced) ringing in I_{D} 414 from T2 to T3 because voltage across the secondary winding 228 is clamped by the output voltage, accordingly, a voltage across the load 267. In some examples, if there were no parasitic capacitances in the circuit, I_{D} 414 would be constant from T1 to T2 and from T3 to T4.

FIG. 4B is a second example phase shift angle control scheme 418 for the CLLLC converter 202 of FIG. 2. The phase shift angle control scheme 418 is illustrated by a timing diagram 420 for the primary switches 242, 244, 246, and 248, with a corresponding graph 422 of current versus time for certain signals of the CLLLC converter 202. A vertical axis of the timing diagram 420 indicates voltage, and a vertical axis of the graph 422 indicates current. A horizontal axis indicates time.

In the timing diagram 420, φ=0.35 radians. Between time T1 and time T2, I_{D} 414 oscillates between 4 Amperes and −4 Amperes. This corresponds to ringing in I_{D} 414 caused by participation of the parasitic capacitances of the secondary switches 258, 260, 262, and 264 in the resonance. There is also ringing in I_{Lr1} 412 corresponding to reflection from the secondary side 222.

At time T2, I_{D} 414 has a second current level 424 equal to approximately 2 Amperes. From time T2 to time T3, In 414 increases from approximately 2 Amperes to 4 Amperes. Because the FIG. 4B second current level 424 is lower than the FIG. 4A first current level 416 (current levels at time T2), less energy is transferred between T2 and T3 using q=0.35 radians than using Q=0.4 radians. Accordingly, gain is higher in FIG. 4A using an increased phase shift relative to FIG. 4B. However, as described above, gain should ideally be lower using an increased phase shift because a portion of a duty cycle during which energy can be transferred is reduced as phase shift is increased. However, gain behavior is altered by the nonlinear, ringing behavior of I_{D} 414 responsive to participation of the secondary side 222 parasitic capacitances in the resonance. Accordingly, participation by parasitic capacitances of the secondary switches 258, 260, 262, and 264 in the resonance of a CLLLC converter 202 reduces predictability of phase shift control for gain adjustment, such as in a light load context.

FIG. 5 is a third example phase shift angle control scheme 500 for the CLLLC converter 202 of FIG. 2, according to an embodiment of this disclosure. The phase shift angle control scheme 500 is illustrated by a third timing diagram 502 for the primary switches 242, 244, 246, and 248, with a corresponding third graph 504 of current versus time for certain signals of the CLLLC converter 202. A vertical axis of the timing diagram 502 indicates voltage, and a vertical axis of the graph 504 indicates current. A horizontal axis indicates time. The timing diagram 502 shows an S6/S8 control voltage 506 showing activation timing for both S6 260 and S8 264, and an S5/S7 control voltage 508 showing activation timing for both S5 258 and S7 262. In some examples, the S6/S8 control voltage 506 corresponds to Ves for each of S6 260 and S8 264, and the S5/S7 control voltage 508 corresponds to V_{gs} for each of S5 258 and S7 262.

While the S6/S8 control voltage 506 or the S5/S7 control voltage 508 is high (in the illustrated example, one volt), the corresponding switches S6 260 and S8 264, or S5 258 and S7 262, are turned on. While the S6/S8 control voltage 506 or the S5/S7 control voltage 508 is low (in the illustrated example, zero volts), the corresponding switches S6 260 and S8 264, or S5 258 and S7 262, are turned off.

Between times T1 and T2, the S5/S7 control voltages 508 are high and the S6/S8 control voltages 506 are low, so that high-side secondary switches S5 258 and S7 262 are on and low-side secondary switches S6 260 and S8 264 are off. Also, S1 242 is on and S4 248 is off. While S5 258 and S7 262 are turned on, current flows in the DC direction through a circuit portion that includes S5 258 and S7 262 and not S6 260 and S8 264. This prevents participation of parasitic capacitances of the secondary switches 258, 260, 262, and 264 in the resonance, so that I_{D} 414 is constant or increases gradually during this period. Responsively, the period when S1 242 is on and S4 248 is off has a relatively small effect on a value of I_{D} 414 at the beginning of the period from time T2 to time T3 when S1 242 and S4 248 are both on.

Between times T3 and T4, the S5/S7 control voltages 508 are low and the S6/S8 control voltages 506 are high, so that high-side secondary switches S6 260 and S8 264 are off and low-side secondary switches S6 260 and S8 264 on. Also, S1 242 is off and S4 248 is on. While S6 260 and S8 264 are turned on, current flows in the CD direction through a circuit portion that includes S6 260 and S8 264 and not S5 258 and S7 262. Similarly to S5/S7 above, this prevents participation of corresponding parasitic capacitances in the resonance, so that I_{D} 414 is constant or decreases gradually during this period. Responsively, the period when S2 244 is on and S3 246 is off has a relatively small effect on a value of I_{D} 414 at the beginning of a period when both S2 244 and S3 246 are on.

Note that the pair of secondary switches S5 258 and S7 262 or S6 260 and S8 264 that is turned on to prevent resonance participation corresponds to a direction of current flow through the secondary winding 228 at the time of high-side or low-side switch-pair turn-on. Giving current a path to flow through the secondary side 222 that avoids the parasitic capacitances of the turned-off secondary switches 258, 260, 262, and/or 264 advantageously provides a low impedance current path that reduces or avoids participation of those parasitic capacitances in the resonance, and that fully charges or discharges capacitances in the components that participate in the circuit on the secondary side 222.

Accordingly, the low-side secondary switches S6 260 and S8 264 are turned on for a sufficient period prior to T2 to reduce or prevent nonlinearities in I_{D} 414 that would distort gain of the CLLLC converter 202 during the first phase of the CLLLC converter 202. As described above, the first phase of the converter includes a duration when both S1 242 and S4 248 are on to enable energy transfer.

Similarly, the high-side secondary switches S5 258 and S7 S62 are turned on for a sufficient period prior to T4 to reduce or prevent nonlinearities in I_{D} 414 that would distort gain of the CLLLC converter 202 during the second phase of the CLLLC converter 202. As described above, the second phase of the converter includes a duration when both S2 244 and S3 246 are on to enable energy transfer.

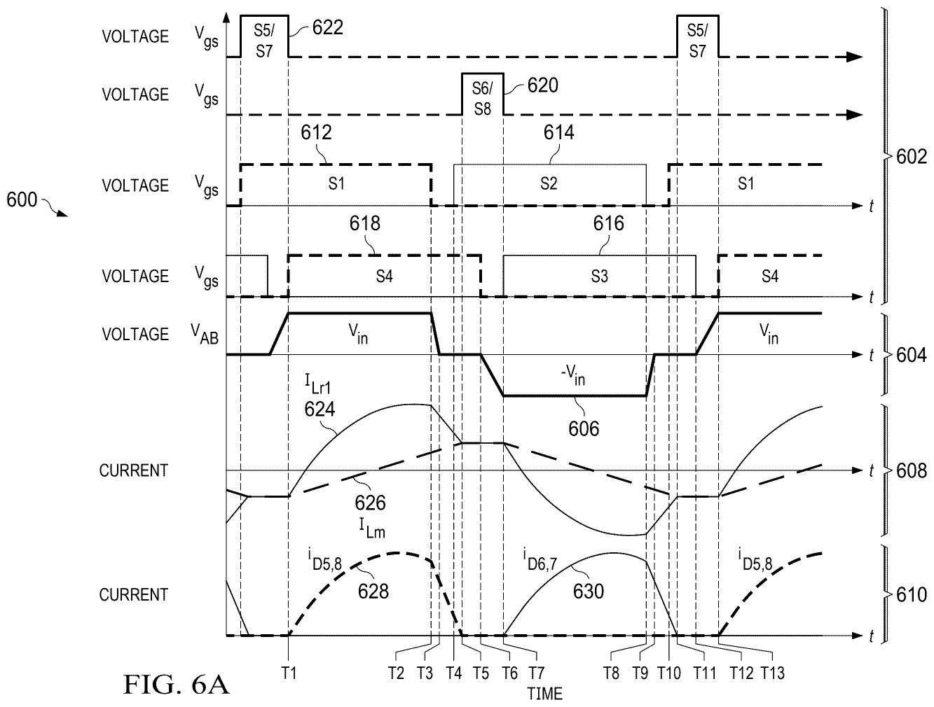

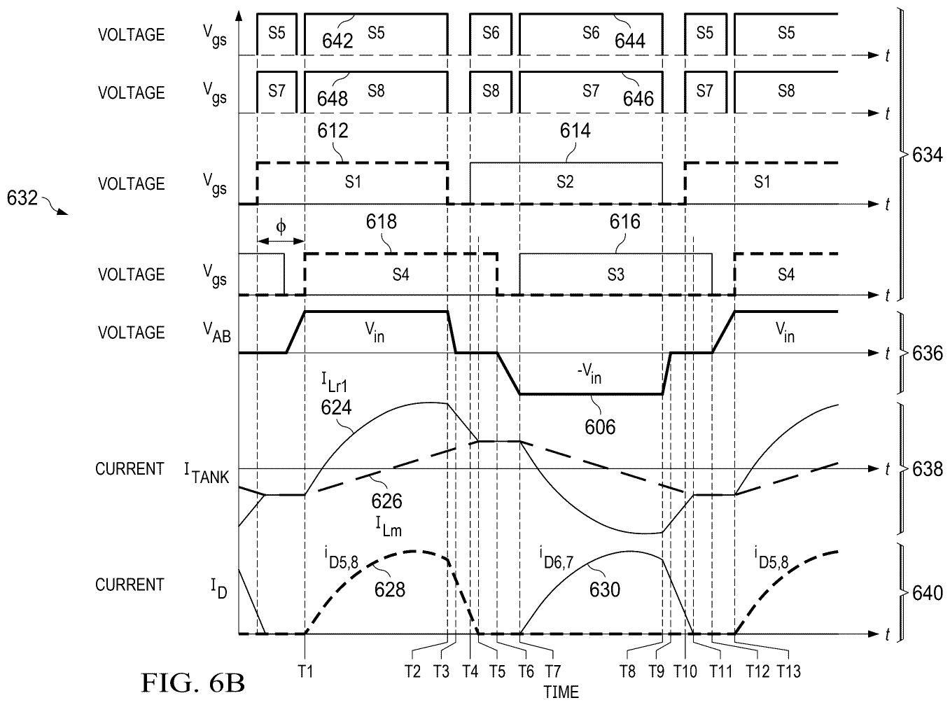

FIG. 6A is an example phase shift control scheme 600 that is a first alternative to the phase shift control scheme 500 of FIG. 5 for the CLLLC converter 202 of FIG. 2, according to an embodiment of this disclosure. The phase shift control scheme 600 is illustrated by a timing diagram 602 for control of the primary switches 242, 244, 246, a graph 604 of voltage (V_{AB}) 606 versus time from node A 268 to node B 270, a graph 608 of current versus time for certain signals of the primary side 220, and a graph 610 of current versus time for certain signals of the secondary side 222. Vertical axes of the timing diagram 602 and the graph 604 of V_{AB} 606 indicate voltage. Vertical axes of the current versus time graphs 608 and 610 indicate current. A horizontal axis indicates time.

The timing diagram 602 includes an S1 control signal 612 corresponding to Ves of S1 242, an S2 control signal 614 corresponding to Ves of S2 244, an S3 control signal 616 corresponding to V_{gs} of S3 246, an S4 control signal 618 corresponding to V_{gs} of S4 248, an S6/S8 control signal 620 corresponding to Ves of each of S6 260 and S8 264, and an S5/S7 control signal 622 corresponding to V_{gs} of each of S5 258 and S7 262.

Control signals for S5 258, S6 260, S7 262, and S8 264 are not shown separately in FIG. 6A. S5 258 and S8 264 are either both on (corresponding to an active rectification mode) or both off (corresponding to diode mode) while both S1 242 and S4 248 are on. S6 260 and S7 262 are either both on (corresponding to the active rectification mode) or both off (corresponding to diode mode) while both S2 244 and S3 246 are on.

The graph 608 includes an I_{Lr1} 624 current signal indicating current through Lᵣ₁ 234, and an ILn 626 current signal indicating current through Lₘ 232. The graph 610 includes an I_{D5,8} 628 current signal indicating current through node D 274 while S5 258 and S8 264 are closed, and an I_{D6,7} 230 current signal indicating current through node D 274 while S6 260 and S7 262 are closed.

At time T1, on the primary side 220, the S1 control signal 612 is high so that S1 242 is on, V_{AB} 606 rises to equal Vᵢₙ, and the S4 control signal 618 goes high to turn on S4 248. This causes I_{Lr1} 624 and I_{Lm} 626 to increase the AB direction. On the primary side 220, because S1 242 and S4 248 are on, then on the secondary side 222, I_{D5,8} 628 increases as energy is transferred from the primary side 220 to the secondary side 222.

At time T2, the S1 control signal 612 goes low so that S1 242 turns off. Responsively, V_{AB} 606, I_{Lr1} 624, and I_{D5,8} 628 start to decrease (I_{Lm} 626 continues to increase in the AB direction). At time T3, V_{AB} 606 decreases to zero volts. At time T4, the S2 control signal 614 goes high so that S2 244 turns on. Accordingly, between times T4 and T6 both S4 618 and S2 614 are turned on. In some examples, both high-side primary switches S1 242 and S3 246 or both low-side primary switches S2 244 and S4 248 are allowed to be on at the same time to facilitate maintaining a constant duty cycle for the primary switches 242, 244, 246, and 248 while in phase shift mode, while allowing a broad range of phase shift angles q.

At time T5, I_{D5,8} 628 decreases to zero, and the S6/S8 control signal 624 goes high so that S6 260 and S8 264 turn on. From time T5 to time T7, while S6 260 and S8 264 are on, I_{Lm} 626 and I_{Lr1} 624 are constant.

At time T6, S4 248 turns off. Responsively, V_{AB} 606 decreases until it reaches −Vᵢₙ at T7. At T7, the S3 control signal 616 goes high so that S3 246 turns on. From time T7 to time T8, S2 244 and S3 246 are both on, so that I_{D6,7} 630 increases, and I_{Lr1} 624 and I_{Lm} 626 decrease (increase in magnitude in a negative direction).

At time T8, the S2 control signal 614 goes low so that S2 244 turns off. Responsively, V_{AB} 606 increases until it reaches zero at time T9, and I_{D6,7} decreases from time T8 until it reaches zero at time T11. At time T10, the S1 control signal 612 goes high so that S1 242 turns on. At time T11, the S5/S7 control signals 622 go high so that S5 258 and S7 262 turn on. From time T11 to time T13, while S5 258 and S7 262 are on, I_{Lm} 626 and I_{Lr1} 624 are constant. At time T12, the S3 control signal 616 turns off, so that V_{AB} 606 increases until it reaches Vᵢₙ at time T13. At time T13, the S4 control signal 618 goes high so that S4 248 turns on and the S5/S7 control signals 622 go low so that S5 258 and S7 262 turn off. While S1 242 and S4 248 are on I_{D5,8} 628 increases . . .

FIG. 6B is an example timing diagram phase shift control scheme 632 that is a second alternative to the phase shift control scheme 500 of FIG. 5 for the CLLLC converter 202 of FIG. 2, according to an embodiment of this disclosure. The phase shift control scheme 632 is illustrated by a timing diagram 634 for control of the primary switches 242, 244, 246, a graph 636 of V_{AB} 606, a graph 638 of current versus time for certain signals of the primary side 220, and a graph 640 of current versus time for certain signals of the secondary side 222. Vertical axes of the timing diagram 634 and the graph 636 of V_{AB} 606 indicate voltage. Vertical axes of the current versus time graphs 608 and 610 indicate current. A horizontal axis indicates time. Note that there may be slight timing mismatches between control signals 642, 644, 646, and 648 and current signals 628 and 630 of the secondary side 222 as illustrated in FIG. 6B.

In some embodiments, sufficiently prior to time T1 to allow for a dead time prior to a next duration of active rectification, the S5 control signal 642 and the S7 control signal 646 go low so that S5 258 and S7 262 turn off. At time T1, following the dead time, the S5 control signal 642 and the S8 control signal 648 go high so that S5 258 and S8 264 turns on. S1 242 and S4 248 are on from time T1 to time T2 to transfer energy to the secondary side 222. Accordingly, S5 258 and S8 264 are both on to perform synchronous rectification until time T2, when the S5 and S8 control signals 642 and 648 go low so that S5 258 and S8 264 turn off. At time T4, the S6 control signal 644 and the S8 control signal 648 go high so that S6 260 and S8 264 turn on. From this time until shortly before time T7 S6 260 and S8 264 are both on to prevent secondary side 222 parasitic capacitances from participating in the resonance.

In some embodiments, sufficiently prior to time T7 to allow for a dead time prior to a next duration of active rectification, the S6 and S8 control signals 644 and 648 go low so that S6 260 and S8 264 turn off. At time T7, following the dead time, the S6 control signal 644 and the S7 control signal 646 go high so that S6 260 and S7 262 turn on. S2 244 and S3 246 are on from time T7 to time T8 to transfer energy to the secondary side 222. Accordingly, S6 260 and S7 262 are both on to perform synchronous rectification until time T8, when the S6 and S7 control signals 644 and 646 go low so that S6 260 and S7 262 turn off. At time T10, the S5 control signal 642 and the S7 control signal 646 go high so that S5 258 and S7 262 turn on. Time T13 is similar to time T1.

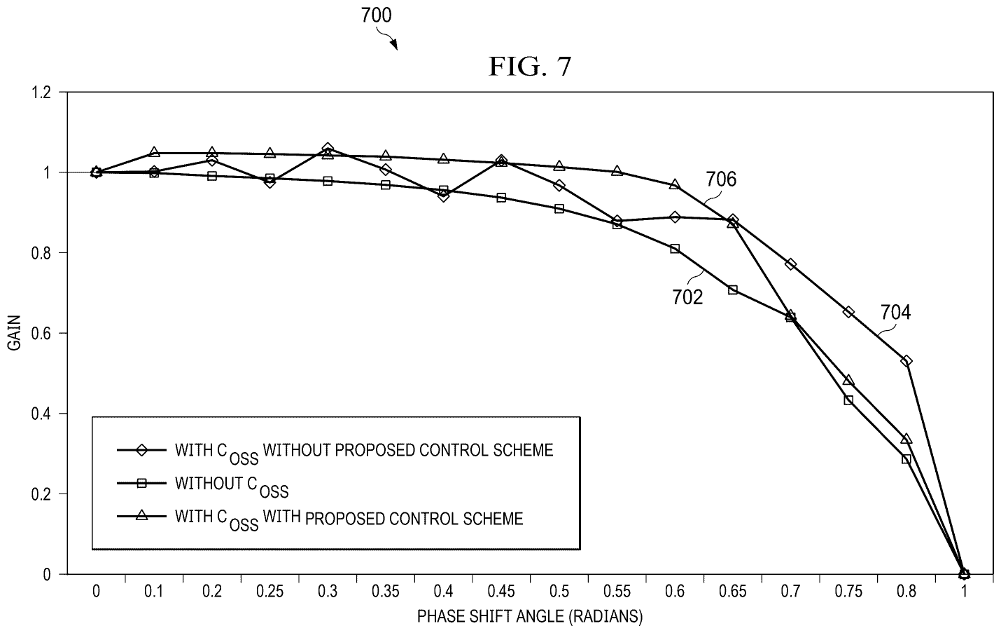

FIG. 7 is an example graph 700 of gain versus phase shift angle for the CLLLC converter 202 of FIG. 2 using the control scheme 500 of FIG. 5, according to an embodiment of this disclosure. A vertical axis corresponds to gain and a horizontal axis corresponds to phase shift angle (in radians).

A first gain line 702 corresponds to phase shift angle control of the switches 242, 244, 246, 248, 258, 260, 262, and 264 as described with respect to FIGS. 4A and 4B, with gain response as if the secondary switches 258, 260, 262, and 264 had no parasitic capacitance (without C_{OSS}). The first gain line 702 indicates a smooth decrease in gain as phase shift angle increases. C_{OSS} refers to the parasitic capacitances of the secondary switches 258, 260, 262, and 264.

A second gain line 704 corresponds to phase shift angle control of the switches 242, 244, 246, 248, 258, 260, 262, and 264 as described with respect to FIGS. 4A and 4B, with gain response including participation of the parasitic capacitances of the secondary switches 258, 260, 262, and 264 in the resonance (with C_{OSS} and without proposed control scheme). The second gain line 704 indicates fluctuating gain as phase shift angle increases, responsive to the nonlinearities in signal behavior described with respect to FIGS. 4A and 4B.

A third gain line 706 corresponds to phase shift angle control of the switches 242, 244, 246, 248, 258, 260, 262, and 264 as described with respect to FIG. 5 or 6A (with C_{OSS} and with proposed control scheme). Accordingly, the third gain line 706 is responsive to reduction or elimination of participation of the parasitic capacitances of the secondary switches 258, 260, 262, and 264 in the resonance. The third gain line 706 shows gain smoothly decreasing in response to increasing phase shift angle, for most or all available phase shift angles. In some examples, a phase shift angle of zero or 0.1 radians corresponds to a threshold, such that control for operation with a phase shift angle below that threshold corresponds to a return to operation using frequency modulation.

FIG. 8A is a flow diagram of a first example process 800 for control of the power converter system 200 of FIG. 2, according to an embodiment of this disclosure. Process 800 may be implemented by controller 204.

In step 802, operate the CLLLC converter 202 in frequency modulation mode, as described above with respect to FIG. 3. In frequency modulation mode, a gain of the CLLLC converter 202 is selected by controlling the switches 242, 244, 246, 248, 258, 260, 262, and 264 to switch at a corresponding modulation frequency Fmod. In step 804, if Fmod equals (or exceeds) a maximum modulation frequency of the CLLLC converter 202 then proceed to step 806 (operate in phase shift mode), otherwise return to step 802 (continue in frequency modulation mode). In an example, a maximum modulation frequency is 400 kilohertz. In step 806, the modulation frequency is set to equal the maximum modulation frequency and the CLLLC converter 202 is operated in phase shift mode. In step 808, if the phase shift angle is lower than a threshold then go to step 802 (operate in frequency modulation mode), otherwise return to step 806 (continue in phase shift mode). In an example, a phase shift angle threshold is zero radians.

FIG. 8B is a flow diagram of an example process 810 for control of the power converter system 200 of FIG. 2 in phase shift mode, according to an embodiment of this disclosure. Process 810 may be implemented by controller 204.

The process 810 corresponds to diode mode rectification on the secondary side 222. In some examples, active rectification is used.

Starting description of the process 810 in the middle of a switching cycle of the CLLLC converter 202, S3 616 is turned on. In step 812, turn on S1 242. Accordingly, turn on a first high-side primary switch. In step 814, turn on S5 258 and S7 262. Accordingly, turn on both high-side secondary switches to avoid parasitic capacitance participation in the resonance. In step 816, turn off S3 616.

In step 818, after a time following step 812 corresponding to the phase shift angle φ, turn off S5 260 and S7 262 and turn on S4 248. Accordingly, turn on a first low-side primary switch that provides a current path on the primary side 220 from the voltage source 238 through the first high-side switch, the primary side 220 resonance (Lᵣ₁ 234, Lₘ 232, and Cᵣ₁ 236), and the first low-side switch. In some examples, S5 258 remains on and S8 264 is turned on to enable active rectification while S1 242 and S4 248 are on. In step 820, after a duration corresponding to a duty cycle of S1 242 and S4 248 (in radians) minus φ, turn off S1 242.

In step 822, after a designed dead time, turn on S2 244. Accordingly, turn on a first low-side primary switch. In step 824, turn on S6 260 and S8 264. Accordingly, turn on both low-side secondary switches to avoid parasitic capacitance participation in the resonance. In step 826, turn off S4 618. In step 828, after a time following step 822 corresponding to the phase shift angle φ, turn off S6 260 and S8 264 and turn on S3 252. Accordingly, turn on a second high-side primary switch that provides a current path on the primary side 220 from the voltage source 238 through the first low-side switch, the primary side 220 resonance (Lᵣ₁ 234, Lₘ 232, and Cᵣ₁ 236), and the second high-side switch. In some examples, S6 260 remains on and S7 262 is turned on to enable active rectification while S1 242 and S4 248 are on. In step 830, turn off S2 244.

Modifications are possible in the described examples, and other examples are possible, within the scope of the claims.

In some examples, control schema described herein are applied to an LLC converter.

In some examples, a current path of a switch 242, 244, 246, 248, 258, 260, 262, and/or 264 can be described as a source-drain path of the switch 242, 244, 246, 248, 258, 260, 262, or 264, or as a path of relatively lower resistance while the switch 242, 244, 246, 248, 258, 260, 262, or 264 is on and relatively higher resistance while the switch 242, 244, 246, 248, 258, 260, 262, or 264 is off. In some examples, a current path of a switch 242, 244, 246, 248, 258, 260, 262, and/or 264 corresponds to a conductive path between the high-side terminal and the low-side terminal of the switch 242, 244, 246, 248, 258, 260, 262, and/or 264.

In some examples, a power converter system 200 includes more, fewer, or different sensors than those described above, or the sensors are differently connected. In some examples, a power converter system 200 does not include a voltage sensor 210 or does not include a current sensor 212.

In some examples, the power converter system 200 is included in an automobile or other motorized vehicle. In some examples, the load 267 corresponds to a battery and the voltage source 238 corresponds to a charging station or alternator, and the charging station (or alternator) can be disconnected and the primary side 220 can be switchably connected to an electric motor to enable the battery to provide power to the electric motor during a drive function of the motorized vehicle.

In some examples, a CLLLC converter 202 is controlled to regulate a voltage (e.g., using voltage sensor 210). In some examples, a CLLLC converter 202 is controlled to regulate a current (e.g., using current sensor 212).

In some examples, a control circuit is used to control the PWM circuit 218. In some examples, a control circuit is used instead of a processor to control the PWM circuit 218. In some examples such a control circuit and/or PWM circuit 218 is not included within an IC such as the control IC 204. In some examples, a control IC 204 does not include a memory such as the memory 216.

In some examples, a processor 214 is a central processing unit (CPU), digital signal processor (DSP), or microcontroller unit (MCU).

In some examples, processes described herein, and/or functionality of the control IC 204 described herein, are performed using hardware, software, or a combination of hardware and software.

In some examples, Lᵣ₁ 234 or Lᵣ₂ 250 is an external inductor or a leakage inductance of the transformer 224.

In some examples, one or more of the switches 242, 244, 246, 248, 258, 260, 262, and/or 264 includes multiple transistors (or equivalent devices) coupled in parallel.

This disclosure has attributed functionality to the processor 214 and the PWM circuit 218. The processor 214 or the PWM circuit 218 may include one or more processors. The processor 214 or the PWM circuit 218 may include any combination of integrated circuitry, discrete logic circuitry, or analog circuitry, such as one or more microprocessors, microcontrollers, digital signal processors, application specific integrated circuits, central processing units, graphics processing units, field-programmable gate arrays, and/or any other processing resources. In some examples, the processor 214 or the PWM circuit 218 may include multiple components, such as any combination of the processing resources listed above, as well as other discrete or integrated logic circuitry, and/or analog circuitry.

Example embodiments of the present disclosure are summarized here. Other embodiments can also be understood from the entirety of the specification and the claims filed herein.

Example 1. A resonant converter including: a primary side including a primary full bridge coupled to a primary winding, the primary full bridge including first and second high-side primary switches and first and second low-side primary switches; a secondary side including a secondary full bridge coupled to a secondary winding, the secondary full bridge including two high-side secondary switches and two low-side secondary switches; and a controller configured to: operate the resonant converter in a phase shift mode, the phase shift mode including an overlapping phase in which the first high-side primary switch and the first low-side primary switch are closed, and a non-overlapping phase in which one of the first high-side primary switch and the first low-side primary switch is closed and the other of the first high-side primary switch and the first low-side primary switch is open; and close either the two high-side secondary switches or the two low-side secondary switches during a portion of the non-overlapping phase.

Example 2. The resonant converter of example 1, where the controller is configured to operate the secondary full bridge during the overlapping phase according to synchronous rectification.

Example 3. The resonant converter of one of examples 1 or 2, where the secondary full bridge is configured to operate in diode mode during the phase shift mode.

Example 4. The resonant converter of one of examples 1 to 3, where the controller is configured to operate the resonant converter in a frequency mode having an operating range from a minimum frequency to a maximum frequency, where the controller is configured to operate the resonant converter in the phase shift mode at the maximum frequency.

Example 5. The resonant converter of one of examples 1 to 4, where the controller is configured to operate the resonant converter in a frequency mode when a load of the resonant converter is higher than a threshold, and operate the resonant converter in the phase shift mode when the load is lower than the threshold.

Example 6. The resonant converter of one of examples 1 to 5, where the primary winding includes first and second terminals, the primary side further including: a first inductor coupled to a first terminal of the primary winding; and a first capacitor coupled to a second terminal of the primary winding.

Example 7. The resonant converter of one of examples 1 to 6, further including: a first input terminal coupled to the first and second high-side primary switches; and a second input terminal coupled to the first and second low-side primary switches, where the first high-side primary switch has a current path coupled between the first terminal and the first inductor, and the first low-side primary switch has a current path coupled between the second input terminal and the first inductor.

Example 8. The resonant converter of one of examples 1 to 7, where the secondary winding includes first and second terminals, the secondary side further including: a second inductor coupled to the first terminal of the secondary winding; and a second capacitor coupled to the second terminal of the secondary winding.

Example 9. The resonant converter of one of examples 1 to 8, where the secondary winding includes first and second terminals, the secondary side further including: an inductor coupled to the first terminal of the secondary winding; and a capacitor coupled to the second terminal of the secondary winding.

Example 10. The resonant converter of one of examples 1 to 9, further including a first output terminal coupled to the two high-side secondary switches, and a second output terminal coupled to the two low-side secondary switches, where the two high-side secondary switches include first and second high-side secondary switches, where the two low-side secondary switches includes first and second low-side secondary switches, where the first high-side secondary switch has a current path coupled between the first output terminal and the inductor, where the second high-side secondary switch has a current path coupled between the first output terminal and the capacitor, where the first low-side secondary switch has a current path coupled between the second output terminal and the inductor, and where the second low-side secondary switch has a current path coupled between the second output terminal and the capacitor.

Example 11. The resonant converter of one of examples 1 to 10, further including a gate driver coupled to the secondary full bridge, where the controller is configured to close either the two high-side secondary switches or the two low-side secondary switches using the gate driver.

Example 12. The resonant converter of one of examples 1 to 11, where the resonant converter is a bidirectional converter.

Example 13. The resonant converter of one of examples 1 to 12, where the resonant converter is an isolated DC/DC converter.

Example 14. The resonant converter of one of examples 1 to 13, where the primary full bridge is configured to receive a first DC voltage, and the secondary full bridge is configured to provide a second DC voltage that is higher than the first DC voltage.

Example 15. The resonant converter of one of examples 1 to 14, where the primary full bridge is configured to receive a first DC voltage, and the secondary full bridge is configured to provide a second DC voltage that is lower than the first DC voltage.

Example 16. The resonant converter of one of examples 1 to 15, where the resonant converter is a CLLLC converter.

Example 17. The resonant converter of one of examples 1 to 16, including an output terminal, where the controller is configured to regulate an output voltage at the output terminal to a target voltage.

Example 18. The resonant converter of one of examples 1 to 17, including an output terminal, where the controller is configured to regulate an output current flowing through the output terminal to a target current.

Example 19. The resonant converter of one of examples 1 to 18, where each of the first and second primary high-side and first and second primary low-side switches includes a GaN transistor.

Example 20. The resonant converter of one of examples 1 to 19, where each of the two secondary high-side and two secondary low-side switches includes a SiGe transistor.

Example 21. The resonant converter of one of examples 1 to 20, where the controller is configured to, during the phase shift mode, drive the primary full bridge with a signal having a fixed duty cycle.

Example 22. A device including: a transformer having primary and secondary windings, each of the primary and secondary windings having respective first and second terminals; first and second high-side primary switches that each have respective first, second, and control terminals; first and second low-side primary switches that each have respective first, second, and control terminals, the second terminal of the first high-side primary switch coupled to the first terminal of the first low-side primary switch and the first terminal of the primary winding, and the second terminal of the second high-side primary switch coupled to the first terminal of the second low-side primary switch and the second terminal of the primary winding; first and second high-side secondary switches that each have respective first, second, and control terminals; first and second low-side secondary switches that each have respective first, second, and control terminals, the second terminal of the first high-side secondary switch coupled to the first terminal of the first low-side secondary switch and the first terminal of the secondary winding, and the second terminal of the second high-side secondary switch coupled to the first terminal of the second low-side secondary switch and the second terminal of the secondary winding; and a controller configured to: close the first and second high-side secondary switches when the first high-side primary switch is closed and the second low-side primary switch is open; and close the first and second low-side secondary switches when the second high-side primary switch is closed and the first low-side primary switch is open.

Example 23. The device of example 22, where the first and second high-side secondary switches and the first and second low-side secondary switches are part of a secondary full bridge, the device further including a battery coupled to the secondary full bridge.

Example 24. The device of one of examples 22 or 23, where the first and second high-side primary switches and the first and second low-side primary switches are part of a primary full bridge, the device further including a battery charger coupled to the primary full bridge.

Example 25. The device of one of examples 22 to 24, where the first and second high-side primary switches and the first and second low-side primary switches are part of a primary full bridge, the device further including a battery coupled to the primary full bridge.

Example 26. The device of one of examples 22 to 25, where the first and second high-side secondary switches and the first and second low-side secondary switches are part of a secondary full bridge, the device further including a motor drive coupled to the secondary full bridge.

Example 27. The device of one of examples 22 to 26, where the first and second high-side secondary switches and the first and second low-side secondary switches are part of a secondary full bridge, the device further including a signal sensor having an input and an output, the output of the signal sensor coupled to the controller, and the input of the signal sensor coupled to the secondary full bridge.

Example 28. The device of one of examples 22 to 27, where the signal sensor is a voltage sensor.

Example 29. The device of one of examples 22 to 28, where the signal sensor is a current sensor.

Example 30. The device of one of examples 22 to 29, where the controller is configured to operate the device in a phase shift mode in response to the output of the signal sensor.

Example 31. The device of one of examples 22 to 30, where the controller is configured to operate the device in a frequency mode in response to the output of the signal sensor.

Example 32. An integrated circuit (IC) including: a pulse-width modulation (PWM) circuit; and a controller configured to: operate, using the PWM circuit, a resonant converter in a phase shift mode, the phase shift mode including an overlapping phase in which a first high-side primary switch of a primary full bridge coupled to a primary winding and a first low-side primary switch of the primary full bridge are closed, and a non-overlapping phase in which the first high-side primary switch is closed and the first low-side primary switch is open; and close two high-side secondary switches of a secondary full bridge of the resonant converter during the non-overlapping phase.

Example 33. The IC of example 32, further including the primary full bridge and the secondary full bridge.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

The techniques described in this disclosure may also be embodied or encoded in an article of manufacture including a non-transitory computer-readable storage medium, such as memory 140. Example non-transitory computer-readable storage media may include random access memory (RAM), read-only memory (ROM), programmable ROM, erasable programmable ROM, electronically erasable programmable ROM, flash memory, a solid-state drive, a hard disk, magnetic media, optical media, or any other computer readable storage devices or tangible computer readable media. The term “non-transitory” may indicate that the storage medium is not embodied in a carrier wave or a propagated signal. In certain examples, a non-transitory storage medium may store data that can, over time, change (e.g., in RAM or cache).

While the use of particular transistors are described herein, other transistors (or equivalent devices) may be used instead with little or no change to the remaining circuitry. For example, a metal-oxide-silicon FET (“MOSFET”) (such as an n-channel MOSFET, nMOSFET, or a p-channel MOSFET, pMOSFET), a bipolar junction transistor (BJT—e.g. NPN or PNP), insulated gate bipolar transistors (IGBTs), and/or junction field effect transistor (JFET) may be used in place of or in conjunction with the devices disclosed herein. The transistors may be depletion mode devices, drain-extended devices, enhancement mode devices, natural transistors or other type of device structure transistors. Furthermore, the devices may be implemented in/over a silicon substrate (Si), a silicon carbide substrate (SiC), a silicon germanium (SiGe) substrate, a gallium nitride substrate (GaN) or a gallium arsenide substrate (GaAs).

Circuits described herein may be reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples may be included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means+/−10 percent of the stated value, or, if the value is zero, a reasonable range of values around zero.

While this disclosure has been described with reference to illustrative embodiments, this description is not limiting. Various modifications and combinations of the illustrative embodiments, as well as other embodiments, will be apparent to persons skilled in the art upon reference to the description.

What is claimed is:

1. A resonant converter comprising:
a primary side comprising a primary full bridge coupled to a primary winding, the primary full bridge including first and second high-side primary switches and first and second low-side primary switches;
a secondary side comprising a secondary full bridge coupled to a secondary winding, the secondary full bridge including two high-side secondary switches and two low-side secondary switches; and
a controller configured to:
operate the resonant converter in a phase shift mode, the phase shift mode comprising an overlapping phase in which the first high-side primary switch and the first low-side primary switch are closed, and a non-overlapping phase in which one of the first high-side primary switch and the first low-side primary switch is closed and the other of the first high-side primary switch and the first low-side primary switch is open; and
close either the two high-side secondary switches or the two low-side secondary switches during a portion of the non-overlapping phase.

2. The resonant converter of claim 1, wherein the controller is configured to operate the secondary full bridge during the overlapping phase according to synchronous rectification.

3. The resonant converter of claim 1, wherein the secondary full bridge is configured to operate in diode mode during the phase shift mode.

4. The resonant converter of claim 1, wherein the controller is configured to operate the resonant converter in a frequency mode having an operating range from a minimum frequency to a maximum frequency, wherein the controller is configured to operate the resonant converter in the phase shift mode at the maximum frequency.

5. The resonant converter of claim 1, wherein the controller is configured to operate the resonant converter in a frequency mode when a load of the resonant converter is higher than a threshold, and operate the resonant converter in the phase shift mode when the load is lower than the threshold.

6. The resonant converter of claim 1, wherein the primary winding comprises first and second terminals, the primary side further comprising:
a first inductor coupled to a first terminal of the primary winding; and
a first capacitor coupled to a second terminal of the primary winding.

7. The resonant converter of claim 6, further comprising:
a first input terminal coupled to the first and second high-side primary switches; and
a second input terminal coupled to the first and second low-side primary switches, wherein the first high-side primary switch has a current path coupled between the first terminal and the first inductor, and the first low-side primary switch has a current path coupled between the second input terminal and the first inductor.

8. The resonant converter of claim 6, wherein the secondary winding comprises first and second terminals, the secondary side further comprising:
a second inductor coupled to the first terminal of the secondary winding; and
a second capacitor coupled to the second terminal of the secondary winding.

9. The resonant converter of claim 1, wherein the secondary winding comprises first and second terminals, the secondary side further comprising:
an inductor coupled to the first terminal of the secondary winding; and
a capacitor coupled to the second terminal of the secondary winding.

10. The resonant converter of claim 9, further comprising a first output terminal coupled to the two high-side secondary switches, and a second output terminal coupled to the two low-side secondary switches, wherein the two high-side secondary switches comprise first and second high-side secondary switches, wherein the two low-side secondary switches comprises first and second low-side secondary switches, wherein the first high-side secondary switch has a current path coupled between the first output terminal and the inductor, wherein the second high-side secondary switch has a current path coupled between the first output terminal and the capacitor, wherein the first low-side secondary switch has a current path coupled between the second output terminal and the inductor, and wherein the second low-side secondary switch has a current path coupled between the second output terminal and the capacitor.

11. The resonant converter of claim 1, further comprising a gate driver coupled to the secondary full bridge, wherein the controller is configured to close either the two high-side secondary switches or the two low-side secondary switches using the gate driver.

12. The resonant converter of claim 1, wherein the resonant converter is a bidirectional converter.

13. The resonant converter of claim 1, wherein the resonant converter is an isolated DC/DC converter.

14. The resonant converter of claim 1, wherein the primary full bridge is configured to receive a first DC voltage, and the secondary full bridge is configured to provide a second DC voltage that is higher than the first DC voltage.

15. The resonant converter of claim 1, wherein the primary full bridge is configured to receive a first DC voltage, and the secondary full bridge is configured to provide a second DC voltage that is lower than the first DC voltage.

16. The resonant converter of claim 1, wherein the resonant converter is a CLLLC converter.

17. The resonant converter of claim 1, comprising an output terminal, wherein the controller is configured to regulate an output voltage at the output terminal to a target voltage.

18. The resonant converter of claim 1, comprising an output terminal, wherein the controller is configured to regulate an output current flowing through the output terminal to a target current.

19. The resonant converter of claim 1,
wherein each of the first and second primary high-side and first and second primary low-side switches comprises a GaN transistor; or
wherein each of the two secondary high-side and two secondary low-side switches comprises a SiGe transistor.

20. The resonant converter of claim 1, wherein the controller is configured to, during the phase shift mode, drive the primary full bridge with a signal having a fixed duty cycle.

21. A device comprising:
a transformer having primary and secondary windings, each of the primary and secondary windings having respective first and second terminals;
first and second high-side primary switches that each have respective first, second, and control terminals;
first and second low-side primary switches that each have respective first, second, and control terminals, the second terminal of the first high-side primary switch coupled to the first terminal of the first low-side primary switch and the first terminal of the primary winding, and the second terminal of the second high-side primary switch coupled to the first terminal of the second low-side primary switch and the second terminal of the primary winding;
first and second high-side secondary switches that each have respective first, second, and control terminals;
first and second low-side secondary switches that each have respective first, second, and control terminals, the second terminal of the first high-side secondary switch coupled to the first terminal of the first low-side secondary switch and the first terminal of the secondary winding, and the second terminal of the second high-side secondary switch coupled to the first terminal of the second low-side secondary switch and the second terminal of the secondary winding; and
a controller configured to:
close the first and second high-side secondary switches when the first high-side primary switch is closed and the second low-side primary switch is open; and
close the first and second low-side secondary switches when the second high-side primary switch is closed and the first low-side primary switch is open.

22. The device of claim 21,
wherein the first and second high-side primary switches and the first and second low-side primary switches are part of a primary full bridge, the device further comprising a battery charger coupled to the primary full bridge; or
wherein the first and second high-side secondary switches and the first and second low-side secondary switches are part of a secondary full bridge, the device further comprising a battery coupled to the secondary full bridge.

23. The device of claim 21, wherein the first and second high-side primary switches and the first and second low-side primary switches are part of a primary full bridge, the device further comprising a battery coupled to the primary full bridge.

24. The device of claim 23, wherein the first and second high-side secondary switches and the first and second low-side secondary switches are part of a secondary full bridge, the device further comprising a motor drive coupled to the secondary full bridge.

25. The device of claim 21,
wherein the first and second high-side secondary switches and the first and second low-side secondary switches are part of a secondary full bridge, the device further comprising a signal sensor having an input and an output, the output of the signal sensor coupled to the controller, and the input of the signal sensor coupled to the secondary full bridge; and
wherein the controller is configured to operate the device in a phase shift mode or a frequency mode in response to the output of the signal sensor.

26. An integrated circuit (IC) comprising:
a pulse-width modulation (PWM) circuit; and
a controller configured to:
operate, using the PWM circuit, a resonant converter in a phase shift mode, the phase shift mode comprising an overlapping phase in which a first high-side primary switch of a primary full bridge coupled to a primary winding and a first low-side primary switch of the primary full bridge are closed, and a non-overlapping phase in which the first high-side primary switch is closed and the first low-side primary switch is open; and
close two high-side secondary switches of a secondary full bridge of the resonant converter during the non-overlapping phase.

27. The IC of claim 26, further comprising the primary full bridge and the secondary full bridge.
